(19) United States
(12) Patent Application Publication
(10) Pub. No.: US 2026/0004981 A1
(43) Pub. Date: Jan. 1, 2026

(54) MANUAL OVERRIDE SWITCH TO FULFILL UL REQUIREMENT FOR MANUAL AND AUTOMATED SWITCHING IN SMART ISLANDING SWITCH SYSTEMS

(71) Applicant: EATON INTELLIGENT POWER LIMITED, DUBLIN 4 (IE)

(72) Inventors: Himadri Dipakjyoti Sengupta, Pune (IN); Manish Prabhakar Kesarkar, Pune (IN); Suhas Vishwanath Dhakate, Pune (IN); Anuradha Girish Ogale, Pune (IN); Uday Prakashrao Mhaskar, Pune (IN); Mahesh lghe, Pune (IN)

(73) Assignee: EATON INTELLIGENT POWER LIMITED, DUBLIN 4 (IE)

(21) Appl. No.: 18/943,096

(22) Filed: Nov. 11, 2024

(30) Foreign Application Priority Data
Jun. 28, 2024 (IN) 202411049614

(51) Int. Cl. H01H 15/10; H01H 9/02

(52) U.S. Cl. CPC H01H 15/10; H01H 9/02

(57) ABSTRACT

An overlay manual override system is provided to make relay devices compliant with UL 1741. Said relay devices must have a manual switch that can be moved linearly between an ON position, an OFF position, and a NULL position. The system includes an overlay switch that receives the relay's manual switch, an overlay switch holder, an OFF position sensor, an ON position sensor, a cover, and a cover sensor that detects when the cover is open. The overlay switch holder gets fixedly coupled to the relay. The overlay switch can actuate the manual switch between the ON, OFF, and NULL positions. When the overlay switch is in either the ON position or the OFF position, or when the cover is open, the electrical control of the relay cannot override the state of the overlay switch and manual switch, thus making manual override and electrical control of the relay mutually exclusive.

### CROSS REFERENCE TO RELATED APPLICATIONS

This patent application claims priority to Indian Provisional Patent Application No. 202411049614, filed Jun. 28, 2024 and titled, “Manual Override Switch To Fulfil UL Requirement For Manual And Automated Switching In Smart Islanding Switch Systems”, the contents of which are incorporated herein by reference.

### FIELD OF THE INVENTION

The disclosed concept relates generally to relay switches, and in particular, to manual override mechanisms for automated relay switches used with smart islanding switch (SIS) systems.

### BACKGROUND OF THE INVENTION

Smart islanding switch (SIS) systems are often used with DER (distributed energy resource) systems. For SIS systems used with DER systems, manual override switching is required by the UL 1741 standard. That is, UL 1741 requires that a relay switch used with DER systems be configured so that electrical control of the relay switch and manual control of the relay switch are mutually exclusive. Relays that fulfill the UL 1741 requirement are not directly available in the market. Relays typically include a solenoid used to effectuate electrical control of the relay switch and a manual override switch that can be physically moved by a user in order actuate the relay switch. The relays available in the market have a physical linkage between the solenoid actuation and the physical manual override switch, hence, the manual switch will be actuated ON/OFF when the electrical switch is actuated ON/OFF and vice versa. For an existing relay switch, customizing the relay switch in order to make electrical control of the relay switch and manual control of the relay switch mutually exclusive would involve significant time and cost.

There is thus room for improvement in relay switches used with DER systems and in manual override mechanisms therefor.

### SUMMARY OF THE INVENTION

These needs, and others, are met by a disclosed manual override switching system that can be installed on existing relay devices in order to make manual and electrical control of the relay devices mutually exclusive, thus making the relay devices compliant with UL 1741. The overlay system includes an overlay switch that is used to actuate the relay device's manual switch between the manual ON, manual OFF, and manual NULL positions. When the relay manual switch is inserted within the overlay switch and the overlay switch is in either the manual ON position or the manual OFF position, the electrical control of the relay device cannot override the state of the overlay switch and relay manual switch, thus making manual override and electrical control of the relay mutually exclusive.

A manual override system is structured for use with a relay device, the relay device comprising an internal switch that can form a closed current path that conducts current and an open current path that prevents conduction of current, the relay device further comprising an electrical control and a manual switch, the manual switch being structured to be actuated between a manual NULL position, a manual ON position, and a manual OFF position. The manual override system comprises: an overlay switch structured to receive the manual switch; and an overlay switch holder structured to be fixedly coupled to the relay device and to receive the overlay switch. The overlay switch and the overlay switch holder are structured such that, when the manual switch is received in the overlay switch, the overlay switch can be actuated to move the manual switch between the manual NULL position, the manual ON position, and the manual OFF position. The manual ON position corresponds to the internal switch forming the closed current path, and the manual OFF position corresponds to the internal switch forming the open current path. The overlay switch and the overlay switch holder are structured such that, when the manual switch is received in the overlay switch and the overlay switch is in the manual ON position or the manual OFF position, the electrical control is prevented from controlling the internal switch.

### BRIEF DESCRIPTION OF THE DRAWINGS

A full understanding of the invention can be gained from the following description of the preferred embodiments when read in conjunction with the accompanying drawings in which:

FIG. 1 is a perspective view of a manual override switching arrangement, in accordance with an exemplary embodiment of the disclosed concept, the manual override switching arrangement being shown installed on a relay switch device;

FIG. 2A is a sectional view of a first section S1 of the manual override switching arrangement installed on the relay switch device, as indicated by the cutting line S1-S1 in FIG. 1, shown as an isometric view;

FIG. 2B is the section S1 shown in FIG. 2A rotated to an elevation view;

FIG. 3 is a sectional view of a second section S2 of the manual override switching arrangement installed on the relay switch device, as indicated by the cutting line S2-S2 in FIG. 2B, shown as an isometric view;

FIG. 4 is a sectional view of a third section S3 of the manual override switching arrangement installed on the relay switch device, as indicated by the cutting line S3-S3 in FIG. 2B, shown as an isometric view;

FIG. 5A is a logic table showing what state the manual override switching arrangement of FIGS. 1-4 must be in to comply with the UL 1741 requirements for manual override functionality; and

FIG. 5B is a symbolic diagram showing how the manual override switching arrangement of FIGS. 1-4 ensures that an existing relay device's manual switch is in the necessary position under various conditions to meet the UL 1741 requirements.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As used herein, the singular form of “a”, “an”, and “the” include plural references unless the context clearly dictates otherwise.

As employed herein, employed herein, when ordinal terms such as “first” and “second” are used to modify a noun, such use is simply intended to distinguish one item from another, and is not intended to require a sequential order unless specifically stated.

As employed herein, the term “controller” shall mean a programmable analog and/or digital device that can store, retrieve and process data; a processor; a control circuit; a computer; a workstation; a personal computer; a microprocessor; a microcontroller; a microcomputer; a central processing unit; a mainframe computer; a mini-computer; a server; a networked processor; or any suitable processing device or apparatus.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, the term “number” shall mean one or an integer greater than one (i.e., a plurality).

As previously stated, the UL 1741 standard requires manual override switching in relay devices used in conjunction with DERs. Specifically, UL 1741 prohibits a relay device's electrical switching mechanism (e.g. solenoid) from overriding the state of the relay device's manual override switch. It will be appreciated that many modern electrical systems allow a user to remotely actuate switching, for example and without limitation through the use of a mobile phone app. As such, a modern relay device's electrical switching mechanism may be actuated either automatically by a DER and SIS or remotely by a user through means such as a mobile app. Disclosed herein is a manual override switching arrangement that ensures that electrical control of a relay device cannot override the state of the relay device's manual override switch.

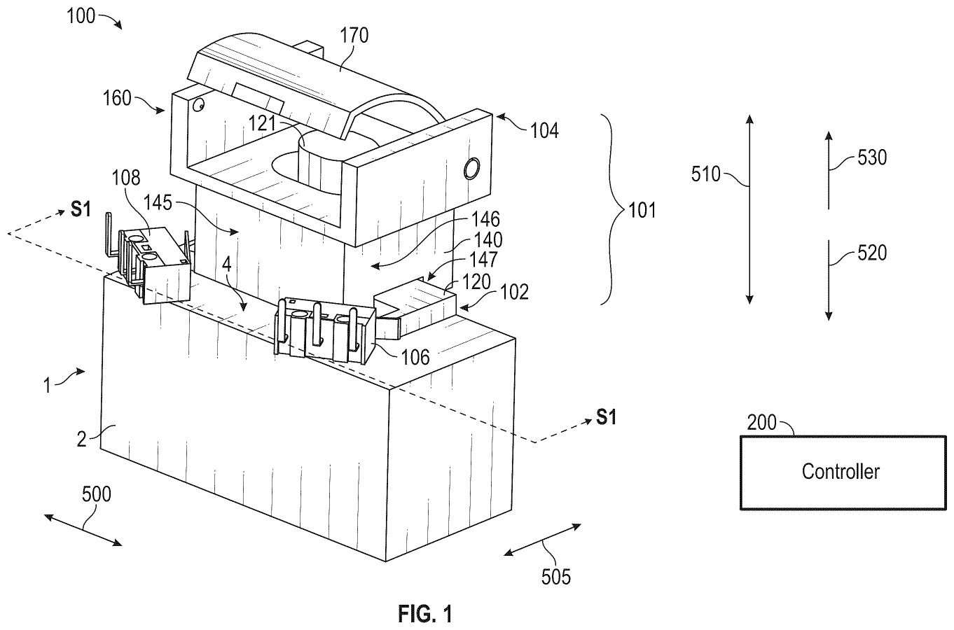

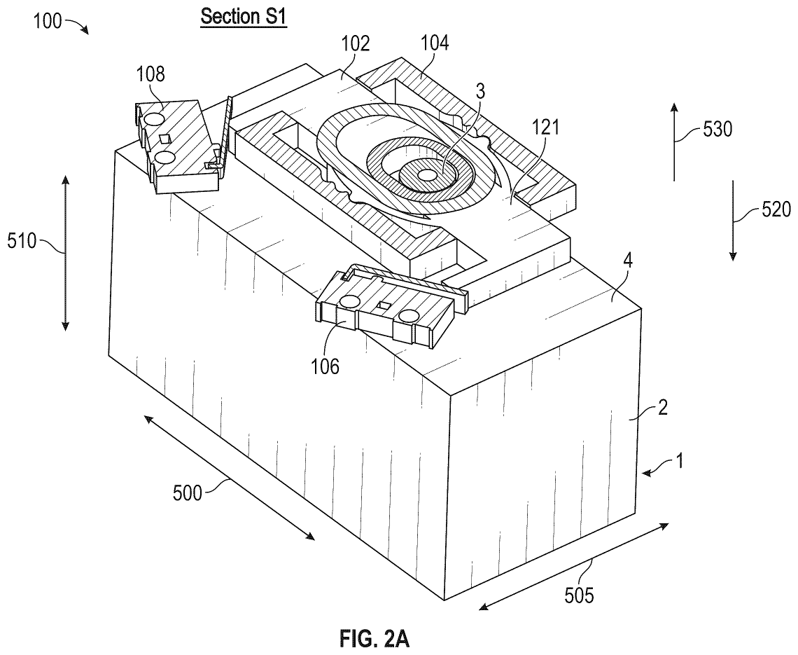

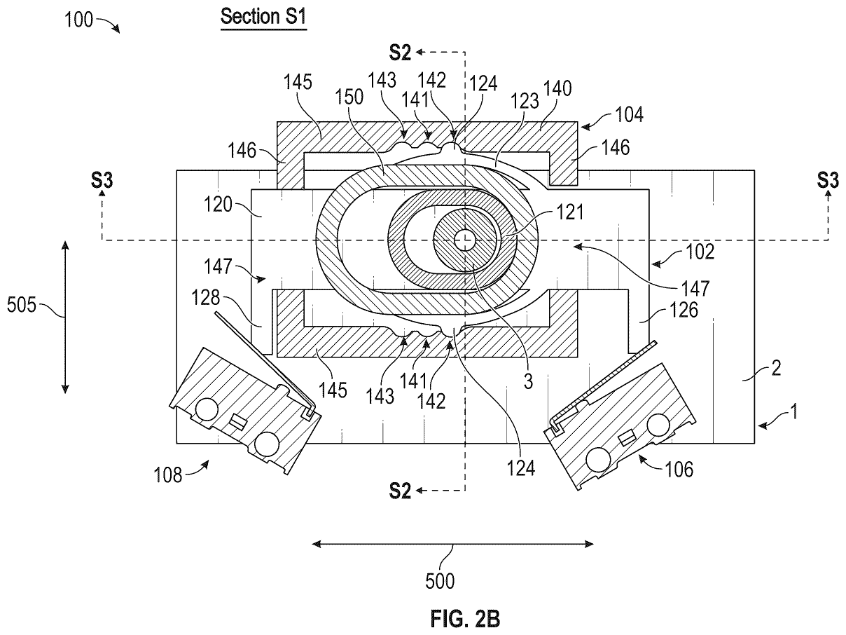

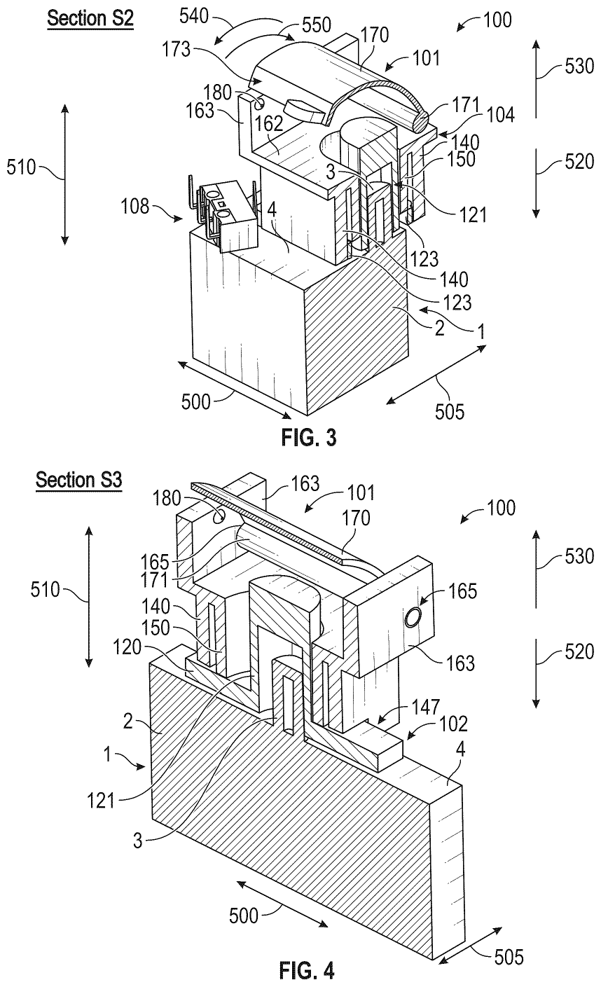

Reference is now made to FIG. 1-4, which show assorted views of a manual override switching system 100 (referred to hereinafter as the “manual override system 100” for brevity), in accordance with an exemplary embodiment of the disclosed concept. The manual override system 100 is structured to be installed on an existing relay device in order to make the existing relay device compliant with UL 1741, and FIGS. 1-4 show one such existing prior art relay device 1 that is intended to be representative of typical existing relay devices. FIG. 1 provides a perspective view of the manual override system 100 installed on the prior art relay device 1. FIG. 2A provides an isometric view of a first section of the manual override system 100 as indicated by the cutting plane line S1-S1 shown in FIG. 1, FIG. 2B provides a view of the first section shown in FIG. 2A rotated to an elevational view, FIG. 3 provides an isometric view of a second section of the manual override system 100 as indicated by the cutting plane line S2-S2 shown in FIG. 2B, and FIG. 4 provides an isometric view of a third section of the manual override system 100 as indicated by the cutting plane line S3-S3 shown in FIG. 2B.

In order to provide a common frame of reference between the figures, three dimensions are labeled in FIGS. 1-4. The labeled dimensions include a width dimension 500, a depth dimension 505, and a height dimension 510. Each of the three dimensions is orthogonal to the other two dimensions. The use of the terms “width”, “depth”, and “height” to refer to the dimensions 500, 505, and 510 is intended solely to facilitate case of explanation and should not be construed as limiting the orientations in which the manual override system 100 can be used.

The prior art relay device 1 includes a main body 2 and manual switch 3, with the manual switch 3 extending from a planar surface 4 of the main body 2 relative to the height dimension 510. In addition to the aforementioned width, depth, and height dimensions 500, 505, and 510, the directional terms “proximal” and “distal” are used herein to describe the positions of components of the manual override system 100 relative to the main body 2 when the manual override system 100 is installed on the relay device 1. Specifically, for any component of the manual override system 100, the portion/end/side of the component that is disposed closest to the planar surface 4 of the main body 2 can be referred to as the “proximal” portion/end/side of the component, and the portion/end/side of the component that is disposed opposite the proximal portion/end/side can be referred to as the “distal” portion/end/side of the component. In addition, movement toward the planar surface 4 in the height dimension 510 can be referred to as being in the “proximal” direction or orientation 520 and is indicated by the arrow 520 in the figures, and movement away from the planar surface 4 in the height dimension 510 can be referred to as being in the “distal” direction or orientation 530 and is indicated by the arrow 530 in the figures.

The manual switch 3 is structured to be manually actuated to move (e.g. via sliding) in the width dimension 500 between an ON position (corresponding to the relay device 1 being in an ON state), an OFF position (corresponding to the relay device 1 being in an OFF state), and a NULL position that is disposed between the ON position and the OFF position. When the relay device 1 is in the ON state, the relay device 1 forms a closed current path that can conduct current. When the relay device 1 is in the OFF state, the relay device 1 forms an open current path that prevents conduction of current. The relay device 1 also comprises a solenoid or other mechanism (referred to hereafter as the “electrical switching mechanism”, the electrical switching mechanism not being visible in the figures) used to actuate electrical/automated switching of the relay between the ON state and the OFF state. The relay device 1 comprises a physical linkage between the manual switch 3 and the electrical switching mechanism such that, when the electrical switching mechanism is automatically or remotely actuated to the ON or OFF state, the manual switch 3 is also actuated to the ON or OFF state, and vice versa. When the manual switch 3 is in the NULL position, the manual switch 3 will not prevent the electrical switching mechanism of the relay device 1 from closing or opening the current path formed by the relay device 1 (i.e. the electrical switching mechanism can change the state of the relay between the ON and OFF states when the manual switch 3 is in the NULL position). As detailed hereinafter, installing the manual override system 100 on the relay device 1 prevents the relay device's electrical switching mechanism from overriding the state of the manual switch 3 when the manual switch 3 is in the ON state or the OFF state.

The manual override system 100 includes an override switch device 101 that comprises an overlay switch 102 and an overlay switch holder 104. In addition to the override switch device 101, the switching arrangement also includes an ON position sensor 106 and an OFF position sensor 108. The manual override system 100 is structured so that, when the manual override system 100 is installed on the relay switch device 1, the manual switch 3 can still be actuated between the ON, OFF, and NULL positions, which will be referred to hereinafter as the “manual ON”, “manual OFF”, and “manual NULL” positions. As detailed further later herein, actuating the overlay switch 102 to an ON position actuates the ON position sensor 106 and actuating the overlay switch 102 to an OFF position actuates the OFF position sensor 108.

The overlay switch 102 comprises a base portion 120 that is structured to be seated on the relay device's planar surface 4 and a switch engaging chamber 121 that extends from the base portion 120 in the distal direction 530. The switch engaging chamber 121 is structured to receive the manual switch 3 of the relay device 1. As perhaps best seen in FIG. 2B, the switch engaging chamber 121 is proportioned so that it is longer than the manual switch 3 in the width dimension 500 and so that it is slightly wider than the manual switch 3 in the depth dimension 505, such that the manual switch 3 fits snugly within the switch engaging ring 121 in the depth dimension 505.

The overlay switch holder 104 is structured to be fixedly coupled to the relay device 1 so as to be seated upon the relay device's planar surface 4. The overlay switch holder 104 comprises an outer border portion 140, an inner ring portion 150 (only visible in FIGS. 2A-4), and a table portion 160 (shown fully in FIG. 1 and shown partially in FIGS. 3 and 4). As shown in FIGS. 2A and 2B, the outer border portion 140 is formed with three pairs of notches corresponding to the three positions that the manual switch 3 can be actuated between: a first pair of notches that can be referred to as the manual NULL notches 141, a second pair of notches that can be referred to as the manual ON notches 142, and a third pair of notches that can be referred to as the manual OFF notches 143. For each pair of notches 141, 142, or 143, the first and second notch in the pair are disposed on opposite sides of the outer border portion 140 relative to the depth dimension 505. The inner ring portion 150 is positioned so as to be completely surrounded by the outer border portion 140, and the inner ring portion 150 and outer border portion 140 are separated by a gap in the width and depth dimensions 500, 505 as seen in FIGS. 2A-4.

As labeled in FIGS. 3 4, the table portion 160 comprises a tabletop 162 and two legs 163 extending from the tabletop 162 in the height dimension 510 (the table portion 160 appears as an inverted table relative to the views shown in the figures). The tabletop 162 is planar such that the majority of its surface area is orthogonal to the height dimension 510. Each leg 163 is planar such that the majority of the surface area of each leg 163 is orthogonal to the majority of the surface area of the tabletop 162, and both legs 163 are parallel to one another. As can be seen in FIGS. 3 and 4, the distal end of the outer border portion 140 and the distal end of the inner ring portion 150 both converge into the tabletop 162. The tabletop 162 comprises an opening through which the switch engaging chamber 121 extends. The switch engaging chamber 121 extends beyond the tabletop 162 in the distal direction 530 and is disposed between the two legs 163 in the width dimension 500.

As can be seen in FIGS. 3 and 4, the inner ring portion 150 does not extend far enough in the proximal direction 520 to contact the relay main body 2 (such that there is a gap between the relay device's planar surface 4 and the proximal end of the inner ring portion 150), while the outer border portion 140 does extend far enough in the proximal direction 520 for its proximal end to contact the relay main body 2. For the specific relay device 1 depicted in the figures, when the switch device 101 is installed on the relay device 1, a portion of the switch device 101 extends beyond the edge of the relay device's planar surface 4 relative to the depth dimension 505, such that only a portion of the outer border portion 140 lies within the edges of the planar surface 4 relative to the depth dimension 505, and it is only this portion of the outer border portion 150 that contacts the planar surface 4 (see, e.g., FIG. 3). It will be appreciated that if the relay device 1 were structured such that the manual switch 3 was positioned further away from the edge of planar surface 4, that it would be possible for the entire outer border portion 140 to lie within the edges of the planar surface 4.

The base portion 120 of the overlay switch 102 is structured to be longer than the outer border portion 140 of the overlay switch holder 104 in the width dimension 500 (see FIGS. 2A-2B and 4), and the base portion 120 is structured to be shorter than the outer border portion 140 in the depth dimension 505 (see FIGS. 2A-2B and 3). The switch engaging chamber 121 of the overlay switch 102 is received within the inner ring potion 150 of the overlay switch holder 104. The inner ring portion 150 is proportioned so that it is longer than the switch engaging chamber 121 in the width dimension 500 and so that it is slightly longer than the switch engaging chamber 121 in the depth dimension 505, such that the switch engaging ring 121 fits snugly within the inner ring portion 150 in the depth dimension 505.

The overlay switch 102 further comprises a notch engaging ring 123 that extends outward from the base portion 120 relative to the depth dimension 505. The notch engaging ring 123 remains inside of the outer border portion 140 at all times. The notch engaging ring 123 is longer than both the base portion 120 and the inner ring portion 150 in the depth dimension 505 (see FIGS. 2A-2B and 3). The notch engaging ring 123 comprises a pair of protrusions 124 (visible only in FIGS. 2A-2B) formed on opposite sides of the base portion 120 relative to the depth dimension 505. For each given pair of notches 141, 142, or 143 of the overlay switch holder 104 (i.e. the manual NULL notches 141, the manual ON notches 142, the manual OFF notches 143), the protrusions 124 are structured to simultaneously engage the two notches within the given notch pair such that both protrusions 124 snap into both notches 141, both notches 142, or both notches 143.

Because the relay device's manual switch 3 fits snugly within the switch engaging chamber 121 relative to the depth dimension 505 and the switch engaging chamber 121 fits snugly within the inner ring portion 150 relative to the depth dimension 505, the switch engaging chamber 121 can be manually actuated from one end of the inner ring portion 150 to the other end (e.g. via sliding) in the width dimension 500 in order to actuate the manual switch 3 without the switch engaging chamber 121 being displaced in the depth dimension 505. That is, the override switch 101 is structured to ensure linear movement of the manual switch 3 in the width dimension 500.

The overlay switch 102 further comprises an ON state indication arm 126 and an OFF state indication arm 128, with each of the arms 126, 128 extending from the base portion 120 in the depth dimension 505. The arms 126 and 128 are disposed at opposite ends of the overlay switch 102 relative to the width dimension 500. When the overlay switch 102 is positioned with the protrusions 124 engaged with the ON position notches 142, the manual switch 3 is in its ON position and the ON state indication arm 126 engages the ON position sensor 106 (as shown in FIGS. 1 and 2A-2B). When the overlay switch 102 is positioned with the protrusions 124 engaged with the OFF position notches 143, the manual switch 3 is in its OFF position and the OFF state indication arm 128 engages the OFF position sensor 108. When the overlay switch 102 is positioned such that the protrusions 124 are engaged with the NULL position notches 141, the manual switch 3 is in its NULL position such that neither position sensor 106, 108 is engaged by the overlay switch 102.

The position sensors 106, 108 are connected to a first signal processing circuit (not pictured in FIGS. 1-4) that is connected to a controller 200 (depicted schematically only in FIG. 1), such that the controller 200 can determine what position the manual switch 3 is in, based on the engagement or lack of engagement between either arm 126, 128 with its corresponding position sensor 106, 108. The controller 200 is provided with the manual override system 100 and is programmed to communicate with the controller (not shown) of the relay device 1. An important aspect of the functionality of the manual override system 100 is that the controller 200 is configured to disable electrical control of the relay device's current path when either the ON position sensor 106 or the OFF position sensor 108 is engaged by the overlay switch 102. Thus, when the overlay switch 102 is in either the manual ON position or the manual OFF position, the state of the overlay switch 102 overrides electrical control of the relay device 1, and when the overlay switch 102 is in the manual NULL position, the electrical control of the relay device 1 determines what the state of the current path is. That is, the firmware of the controller 200 ensures that manual control and electrical control of the relay device 1 are mutually exclusive.

Certain features of the outer border portion 140 should be noted. As numbered in FIGS. 1 and 2B, the outer border portion 140 comprises two long sides 145 (extending in the width dimension 500) that are parallel to one another and two short sides 146 (extending in the depth dimension 505) that are parallel to one another, with the long sides 145 being orthogonal to the short sides 146. One long side 145 lies within the edges of the relay planar surface 4, while the other long side 145 lies outside of the edges of the relay planar surface 4. For the long side 145 that lies within the edges of the planar relay surface 4, the proximal end of that long side 145 contacts the relay main body 2. Relative to the depth dimension 505, a portion of each of the short sides 146 lies within the edges of the relay planar surface 4 and contacts the relay main body 2, while another portion of each of the short sides 146 lies outside of the edges of the relay planar surface 4 and does not contact the relay main body 2. If the relay device's manual switch 3 were positioned further away from the edge of planar surface 4, then it would be possible for both long sides 145 and both short sides 146 to lie within the edges of the planar surface 4. The position of the manual switch may vary somewhat between different relay device models, and the override switch device 101 is designed to ensure that at least one of the long sides 145 and at least a portion of the two short sides 146 lies within the planar surface of whichever relay device the override switch device 101 is installed on.

Each short side 146 is formed with a cutout 147 (best seen in FIGS. 1 and 4) that extends in the depth dimension 505 and the height dimension 510, such that each short side 146 comprises two different lengths in the height dimension 510. When the override switch device 101 is installed on the relay device 1, each cutout 147 extends in the distal direction 530 from the relay planar surface 4. Each cutout 147 is slightly wider than the base portion 120 of the overlay switch 102 relative to the depth dimension 505, and the base portion 120 is received within the cutout 147. As can be seen in FIGS. 2A-2B, the notch engaging ring 123 is wider than the cutout 147 in the depth dimension 505 such that the notch engaging ring 123 cannot fit through the cutout 147, thus limiting the movement of the overlay switch 102 in the width dimension 500.

As shown in FIGS. 1, 3, and 4, the manual override system 100 comprises a lead cover 170 that is rotatably coupled to the table portion 160 of the overlay switch holder 104 and positioned to extend between the two legs 163 of the overlay switch holder 104. As numbered in FIGS. 3-4, the lead cover 170 comprises a hinge rod 171. The hinge rod 171 extends between the two legs 163, with one end of the hinge rod 171 being received within an opening 165 formed in one leg 163 and the other end of the hinge rod 171 being received within an opening 165 formed in the other leg 163. The lead cover 170 can be manually rotated about the hinge rod 171 in order to either cover the manual switch 3 or to expose the manual switch 3. In particular, rotating the lead cover 170 in the direction 540 (labeled in FIG. 3) will cover the manual switch, while rotating the lead cover 170 in the direction 550 (labeled in FIG. 3) will expose the manual switch. The direction 540 is thus referred to hereafter as the “closing direction 540” and the direction 550 is thus referred to hereafter as the “opening direction 550”. When the lead cover 170 is rotated sufficiently in the closing direction 540 such that the lead cover 170 covers the manual switch 3 in both the width dimension 500 and the depth dimension 505, the lead cover 170 is referred to as closed. When the lead cover 170 is rotated sufficiently in the opening direction 550 such that the lead cover 170 does not cover the manual switch 3 in either the width dimension 500 or the depth dimension 505, the lead cover 170 is referred to as open.

A cover position sensor 180 (numbered in FIGS. 3 and 4) is coupled to at least one of the legs 163 and is connected to a second signal processing circuit (not pictured in the figures) that is also connected to the controller 200. The lead cover 170 comprises a front edge 173 (FIG. 3), and the cover position sensor 180 is positioned so to be in close proximity to the front edge 173 when the lead cover 170 is closed. When the front edge 173 is disposed in a first direction relative to the cover position sensor 180, the controller 200 determines that the lead cover 170 is closed, and when the front edge 173 is disposed in a second direction relative to the cover position sensor 180, the controller 200 determines that the lead cover 170 is open. Because the manual switch 3 can only be actuated by the manual override switch 101 when the lead cover 170 is open and not when it is closed, the controller 200 can use the position of the lead cover 170 to make determinations about whether to enable or disable the relay device's electrical actuation functionality. For example, the controller 200 can be programmed to allow automated/remote electrical control of the relay device 1 only when the lead cover 170 is closed and to disable the automated electrical control functionality when the lead cover 170 is open. Disabling electrical control functionality when the lead cover 170 is open is especially practical, because when the lead cover 170 is open, the manual override function either is being used (i.e. the manual switch 3 is not in the manual NULL position) or is about to be used (which can be assumed from the lead cover 170 being open). This prevents there being any conflicts between manual override actions taken in close proximity to automated or remote commands for electrical control, since the manual override is given priority.

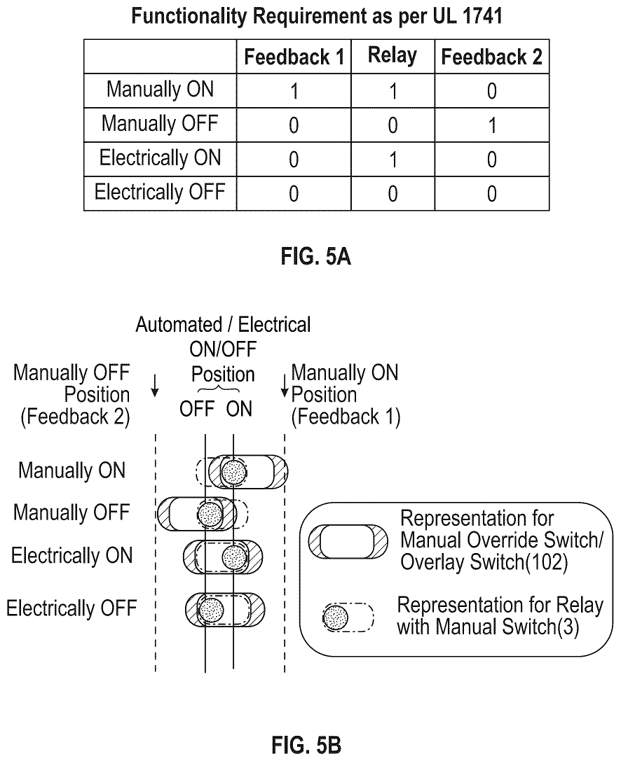

FIG. 5A provides a logic table showing what state the manual override system 100 must be in to comply with the UL 1741 requirements for manual override functionality. In FIG. 5A, “Feedback 1” corresponds to the ON state indication arm 126 engaging the ON position sensor 106, “Feedback 2” corresponds to the OFF state indication arm 128 engaging the OFF position sensor 108, and “Relay” refers to the state of the internal switch within the relay device 1 that determines whether the relay device's current path is closed and can conduct current or whether the relay device's current path is open and prevents conduction of current. FIG. 5B is a symbolic diagram showing how the manual override system 100 ensures that the manual switch 3 is in the position necessary to meet the UL 1741 requirements under various conditions. In particular, FIGS. 5A and 5B show that the relay device's internal switch can only be automatically or remotely electrically actuated when the overlay switch 102 is in the manual NULL position (i.e. when both Feedback 1 and Feedback 2 have a value of 0 in the table shown in FIG. 5A).

When the relay device 1 is installed in an electrical distribution system, it is used to either connect loads to utility power or to connect loads to DER power. When the internal relay switch is in the ON position (either due to being manually ON or electrically ON, as indicated in FIGS. 5A-5B), the relay device is in a grid following state, such that utility power can be provided to the loads via the relay device 1. In contrast, when the internal relay switch is in the OFF position (either due to being manually OFF or electrically OFF, as indicated in FIGS. 5A-5B), the relay device is in an island/grid forming state, such that the open relay isolates the loads from utility power and the loads can instead receive power from the DERs.

In addition, the manual override system 100 is structured to enable a manual override of the relay device's electrical control at any time while preventing the relay device's electrical control from overriding the manual override system 100 when the overlay switch 102 is in either the manual ON or the manual OFF position. It will be appreciated that the structure of the protrusions 124 in the overlay switch 102 and the structure of the notches 141-143 in the overlay switch holder 104 necessitate that manual force be intentionally applied to actuate the overlay switch 102 between the NULL, ON, and OFF positions. That is, the notch and protrusion design of the override switch device 101 prevents electrical actuation of the relay device's internal switch when the override switch device 101 is in either the manual ON position or the manual OFF position.

As is typical of relay devices, the relay device 1 includes a position sensor (not shown in the figures) that detects the state of the internal switch within the relay device 1. The combined use of the relay device's internal position sensor and the manual override switching arrangement's ON and OFF position sensors 106 and 108 to either enable automated/remote electrical control of the internal relay switch (i.e., when neither the ON position sensor 106 nor the OFF position sensor 108 is actuated) or disable the automated electrical control of the internal relay switch (i.e., when either the ON position sensor 106 is actuated or the OFF position sensor 108 is actuated) is a feature not available in existing relay devices or accessories for relay devices. The use of the cover position sensor 180 provides an extra level of risk mitigation by allowing the relay device's software to disable automated or remote electrical control of the relay internal switch when the lead cover 170 is open. Disabling electrical control capability when the lead cover 170 is open mitigates the risk of having inconsistent outcomes that can otherwise occur when the manual switch 3 is being actuated at the same time that the electrical control is being commanded either automatically by a DER or SIS or remotely by a mobile app.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A manual override system structured for use with a relay device, the relay device comprising an internal switch that can form a closed current path that conducts current and an open current path that prevents conduction of current, the relay device further comprising an electrical control and a manual switch, the manual switch being structured to be actuated between a manual NULL position, a manual ON position, and a manual OFF position, the manual override system comprising:
an overlay switch structured to receive the manual switch; and
an overlay switch holder structured to be fixedly coupled to the relay device and to receive the overlay switch;
wherein the overlay switch and the overlay switch holder are structured such that, when the manual switch is received in the overlay switch, the overlay switch can be actuated to move the manual switch between the manual NULL position, the manual ON position, and the manual OFF position,
wherein the manual ON position corresponds to the internal switch forming the closed current path,
wherein the manual OFF position corresponds to the internal switch forming the open current path, and
wherein the overlay switch and the overlay switch holder are structured such that, when the when the manual switch is received in the overlay switch and the overlay switch is in the manual ON position or the manual OFF position, the electrical control is prevented from controlling the internal switch.

2. The manual override system of claim 1,
wherein the overlay switch and the overlay switch holder are structured such that the electrical control can control the internal switch when the overlay switch is in the manual NULL position.

3. The manual override system of claim 1, further comprising:
an ON position sensor;
an OFF position sensor; and
a controller in communication with the ON position sensor, the OFF position sensor and configured to be in communication with a controller of the relay device,
wherein the overlay switch is structured to engage the ON position sensor when the overlay switch is in the manual ON position,
wherein the overlay switch is structured to engage the OFF position sensor when the overlay switch is in the manual OFF position, and
wherein the controller is configured to prevent the electrical control from controlling the internal switch when the overlay switch is engaging either the ON position sensor or the OFF position sensor.

4. The manual override system of claim 3,
wherein the controller is configured to enable the electrical control to control the internal switch when the overlay switch is in the manual NULL position.

5. The manual override system of claim 1, further comprising:
a lead cover coupled to the overlay switch holder; and
a cover position sensor coupled to the overlay switch holder and in communication with the controller,
wherein the cover position sensor is configured to detect when the lead cover is disposed in a first direction relative to the cover position sensor and to detect when the lead cover is disposed in a second direction relative to the cover position sensor,
wherein the first direction corresponds to the lead cover being closed,
wherein the second direction corresponds to the lead cover being open, and
wherein the controller is configured to prevent the electrical control from controlling the internal switch when the lead cover is open.

6. The manual override system of claim 1,
wherein the overlay switch holder comprises an outer border portion,
wherein the outer border portion is formed with three pairs of notches, the three pairs of notches including:
a pair of manual NULL notches corresponding to the manual NULL position,
a pair of manual ON notches corresponding to the manual ON position, and
a pair of manual OFF notches corresponding to the manual OFF position,
wherein the overlay switch comprises a notch engaging ring structured to remain inside of the outer border portion at all times,
wherein the notch engaging ring comprises a pair of protrusions structured to snap into and engage each of the three pairs of notches, and
wherein the overlay switch and manual switch are:
in the manual NULL position when the pair of protrusions are engaging the manual NULL notches,
in the manual ON position when the pair of protrusions are engaging the manual ON notches, and
in the manual OFF position when the pair of protrusions are engaging the manual OFF notches.

7. The manual override system of claim 1, further comprising:
an ON position sensor;
an OFF position sensor; and
a controller in communication with the ON position sensor, the OFF position sensor and configured to be in communication with a controller of the relay device,
wherein the overlay switch holder comprises an outer border portion,
wherein the overlay switch comprises a base portion,
wherein, relative to a width dimension, the outer border portion is longer than the base portion,
wherein the outer border portion comprises two short sides that extend in the depth dimension and are disposed parallel to one another, with each short side being formed with a cutout extending in the depth dimension,
wherein the base portion is longer than the outer border portion in a width dimension that is orthogonal to the width dimension,
wherein the base portion is received within the cutouts and extends outside of the outer border portion such that a first end of the base portion is positioned on a first side of the outer border portion in the width dimension and such that a second end of the base portion disposed opposite the first side is positioned on a second side of the outer portion in the width dimension,
wherein the overlay switch comprises an ON state indication arm that extends in the depth dimension from the first end of the base portion and that is structured to engage the ON position sensor when the overlay switch and the manual switch are in the manual ON position,
wherein the overlay switch comprises an OFF state indication arm that extends in the depth dimension from the second end of the base portion and that is structured to engage the OFF position sensor when the overlay switch and the manual switch are in the manual OFF position, and
wherein the controller is configured to prevent the electrical control from controlling the internal switch when the overlay switch is engaging either the ON position sensor or the OFF position sensor.

8. The manual override system of claim 1,
wherein the overlay switch holder is structured to be coupled to the relay device such that the overlay switch holder is seated on a planar surface of the relay, the planar surface extending in a width dimension and a depth dimension,
wherein the overlay switch comprises a base portion structured to lie on the planar surface and a switch engaging chamber that extends away from the base portion in a distal direction, the distal direction being disposed orthogonally to the width dimension and the depth dimension,
wherein the switch engaging chamber is structured to receive the manual switch such that the manual switch fits snugly within the switch engaging chamber,
wherein the overlay switch holder comprises an inner ring portion that extends away from the base portion in the distal direction, the inner ring portion being slightly longer than the switch engaging chamber in the depth dimension such that the switch engaging ring fits snugly within the inner ring portion in the depth dimension, and the inner ring portion being longer than the switch engaging chamber in the width dimension such that the switch engaging chamber can be actuated between the manual NULL, manual ON, and manual OFF positions in the width dimension.

9. The manual override system of claim 8, further comprising:
a table portion, the table portion comprising:
a tabletop; and
two legs extending from the tabletop in the distal direction; and
a lead cover positioned between the two legs and coupled to the two legs via a hinge rod,
wherein the inner ring portion converges into the tabletop,
wherein the switch engaging chamber extends beyond the tabletop in the distal direction and is disposed between the two legs in the width dimension,
wherein the lead cover is structured to be rotated in a first direction to cover the switch engaging chamber, and
wherein the lead cover is structured to be rotated in a second direction to expose the switch engaging chamber.

10. The manual override system of claim 9, further comprising:
a cover position sensor coupled to one of the legs and in communication with the controller,
wherein the cover position sensor is configured to detect when the lead cover is disposed in the first direction relative to the cover position sensor and to detect when the lead cover is disposed in the second direction relative to the cover position sensor,
wherein the lead cover being disposed in the first direction relative to the cover position sensor corresponds to the lead cover being closed,
wherein the lead cover being disposed in the second direction relative to the cover position sensor corresponds to the lead cover being open, and
wherein the controller is configured to prevent the electrical control from controlling the internal switch when the lead cover is open.
